(19) United States
(12) Patent Application Publication
(10) Pub. No.: US 2006/0239378 A1
(43) Pub. Date: Oct. 26, 2006

(54) Method and apparatus for determining transmitter identification information in terrestrial digital multimedia broadcasting system

(75) Inventors: Suk-Jin Jung, Yongin-si (KR); Kyung-Ha Lee, Seoul (KR); Kyung-Eun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/389,529

(22) Filed: Mar. 27, 2006

(30) Foreign Application Priority Data
Mar. 25, 2005 (KR) 10-2005-0025181
Mar. 23, 2006 (KR) 10-2006-0026494

(51) Int. Cl. H04L 27/00

(52) U.S. Cl. 375/295

(57) ABSTRACT

An apparatus and method are provided for determining transmitter identification information (TII) in terrestrial digital multimedia broadcasting (T-DMB) system. The TII is detected by determining whether the TII occurs during the slot for a null symbol. The detected TII is stored into a TII database preferably continuously until a point of time for a TII update, and a TII detection result is output at the point of time for the TII update.

### CROSS-REFERENCE TO RELATED APPLICATIONS

This application claims the benefit under 35 U.S.C. § 119(a) of Korean Patent Application Nos. 10-2005-0025181 and 10-2006-0026494, filed in the Korean Intellectual Property Office on Mar. 25, 2005, and Mar. 23, 2006, respectively, the entire disclosure of which is herein incorporated herein by reference.

### BACKGROUND OF THE INVENTION

1. Field of the Invention

The present invention relates generally to a method and apparatus for determining transmitter identification information in a terrestrial digital multimedia broadcasting system for providing wireless packets. More particularly, the present invention relates to a method and apparatus for improving a detection capability of transmitter identification information (hereinafter referred to as TII) when a transmitting set converts TII and then transmits information in Terrestrial Digital Multimedia Broadcasting (hereinafter referred to as T-DMB) service.

2. Description of the Related Art

Recently, as the T-DMB service project comes into effect, incidental technical problems to be solved have occurred. One such problem, in relation to distinctions between a broadcasting network and a relay network, particular carriers can carry out the service only if they ensure the quality of TII signal receivers. That is, TII located in the above synchronization channel is the core component of T-DMB as a signal operating the following function. TII is transmitted through the original synchronization channel at T-DMB and classifies each transmitter at a single frequency network (SFN).

Accordingly, the following plan is proposed. The TII signal which was used for transmitter identification in a T-DMB network identification system is used for distinguishing between a broadcasting network and a relay network.

The TII is divided into a broadcasting network and a relay network. That is, in order to distinguish between a broadcasting network and a relay network by building a relay network at a gap missing broadcasting network coverage, dynamic changes of the TII signal are required. As noted above, operating TII signals are transmitted without a protecting process such as a channel coding for superior receiving quality because they are not originally designed for the purpose of dynamic change when transmitting.

Accordingly, even if partial errors occur at a data signal in a multi-channel environment that has the poor receiving qualities of a general wireless environment, the receiver could recover the data signal because the transmitter dealt with the process of channel coding.

However, the transmitter does not take care of the TII signal required in order to descramble this, therefore the receiver cannot recover the data signal correctly. This problem debases the entire receiving efficiency of the receiver.

Accordingly, a need exists for a system and method for effectively and efficiently determining transmitter identification information in a terrestrial digital multimedia broadcasting (T-DMB) system.

### SUMMARY OF THE INVENTION

It is, therefore, an object of embodiments of the present invention to substantially solve the above and other problems, and provide a method and system for increasing a TII signal detection ability which does not have encoding with error detection and error correction in a terrestrial digital multimedia broadcasting (T-DMB) system.

The above and other aspects of embodiments of the present invention can be substantially achieved by providing a method for determining transmitter identification information (TII) in a terrestrial digital multimedia broadcasting (T-DMB) system, the method comprising the steps of detecting the TII by determining whether the TII occurs during the slot for a null symbol, storing the detected TII into a TII database preferably continuously until a point of time for a TII update, and outputting a TII detection result at the point of time for the TII update.

The above and other aspects of embodiments of the present invention can also be achieved by providing a method for determining transmitter identification information (TII) in a terrestrial digital multimedia broadcasting (T-DMB) system, the method comprising the steps of initializing a value of a detection repetition counter, detecting the TII by determining whether the TII occurs during the slot for a null symbol, storing the detected TII into a TII database preferably continuously until a point of time for a TII update, increasing the value of the detection repetition counter except in the case of a point of time for a TII update, and determining whether the value of the detection repetition counter is a repeated number, and outputting a TII detection result at the point of time for the TII update.

The above and other aspects of embodiments of the present invention can also be achieved by providing a transmission system for determining transmitter identification information (TII) in a terrestrial digital multimedia broadcasting (T-DMB) system, the system comprising a key center for storing a value of a Common Interleaved Frame (CIF) counter, a Fast Information Channel (FIC) for including CIF counter update information provided from the key center at a predetermined field when the TII is updated, a Main Service Channel (MSC) including broadcast data, a stream generator for generating a frame by multiplexing the FIC and the MSC, and a transmitter for transmitting the multiplexed frame.

The above and other aspects of embodiments of the present invention can also be achieved by providing a receiver for determining transmitter identification information (TII) in a terrestrial digital multimedia broadcasting (T-DMB) system, comprising a radio frequency (RF) block, a broadcasting data (BD) block for decoding a synchronization channel (SC) in broadcast data provided from the RF block, a detector for detecting the TII by using the TII provided from the RF block with a null symbol and a common interleaved frame (CIF) counter provided from a BD block, and a fast information channel (FIC) decoder for decoding the FIC in broadcast data provided from the BD block. The receiver further comprises a network identification system (NIS) decoder for identifying a network by using the TII and entitlement checking messages (ECM) provided from the FIC decoder, a descrambler for descrambling broadcast data provided from the BD block and a network identification information (NII) provided from the NIS decoder, and a broadcasting data decoder for decoding a main service channel (MSC) of broadcast data provided from the descrambler.

### BRIEF DESCRIPTION OF THE DRAWINGS

The above and other objects and advantages of embodiments of the present invention will become more clearly understood from the following detailed description taken in conjunction with the accompanying drawings, in which like reference numerals will be understood to refer to like parts, components and structures, wherein:

FIG. 1 is a block diagram illustrating a general T-DMB transmission system;

FIG. 2 illustrates a structure of an exemplary T-DMB transmission frame in accordance with an embodiment of the present invention;

FIG. 3 illustrates an exemplary data format that is capable of positioning the value of CIF in FIG Type 0 field for extension 8 in accordance with an embodiment of the present invention;

FIG. 4 is a block diagram illustrating a structure of an exemplary T-DMB transmission system in accordance with an embodiment of the present invention;

FIG. 5 is a block diagram illustrating a structure of an exemplary T-DMB receiver in accordance with an embodiment of the present invention;

FIG. 6 is a flow chart illustrating an exemplary method of detecting TII in a T-DMB receiver in accordance with a first embodiment of the present invention; and

FIG. 7 is a flow chart illustrating an exemplary method of detecting TII in a T-DMB receiver in accordance with a second embodiment of the present invention.

Throughout the drawings, like reference numerals will be understood to refer to like parts, components and structures.

### DETAILED DESCRIPTION OF EXEMPLARY EMBODIMENTS

Certain exemplary embodiments of the present invention will be described in detail herein below with reference to the accompanying drawings. In the following description, detailed descriptions of functions and configurations incorporated herein that are well known to those skilled in the art are omitted for clarity and conciseness.

Embodiments of the present invention relate generally to a method for providing notice of a point of time for a TII update with a receiver in order to enhance TII signal testing power. In doing so, embodiments of the present invention can update a TII periodically at every one of specific points by presenting a point of time for a TII update from key center, update at any point, and then add the value of a CIF counter corresponding to that configuration to a fast information channel (FIC). That is, it is preferable that embodiments of the present invention provide a method for providing notice of a point of time for a TII update from a transmission system with a receiver.

A first exemplary embodiment comprises a method for fixing a point of time for a TII update. The CIF counter can be used at a standard point. The CIF counter is allocated to each CIF as a counter value of a 13 bit (the upper 5 bits +the lower 8 bits) Digital Audio Broadcasting (DAB) logical frame (wherein, 1 Frame consists of 4 CIF, and the CIF can consist of a maximum 64 subchannels by 24 ms, as in the case of T-DMB broadcasting mode 1 in Korea). The value of the CIF counter varies between 0˜5000 (specifically, the upper bit between 0˜19, and the lower bit between 0˜249). The receiver can provide notice of a point of time for a TII update by monitoring the CIF counter if the TII is updated periodically.

Moreover, TII cannot be updated at a point of time for a TII update, but receiving capacity can be improved by using the repetition of the same signal because TII will not be changed during that period.

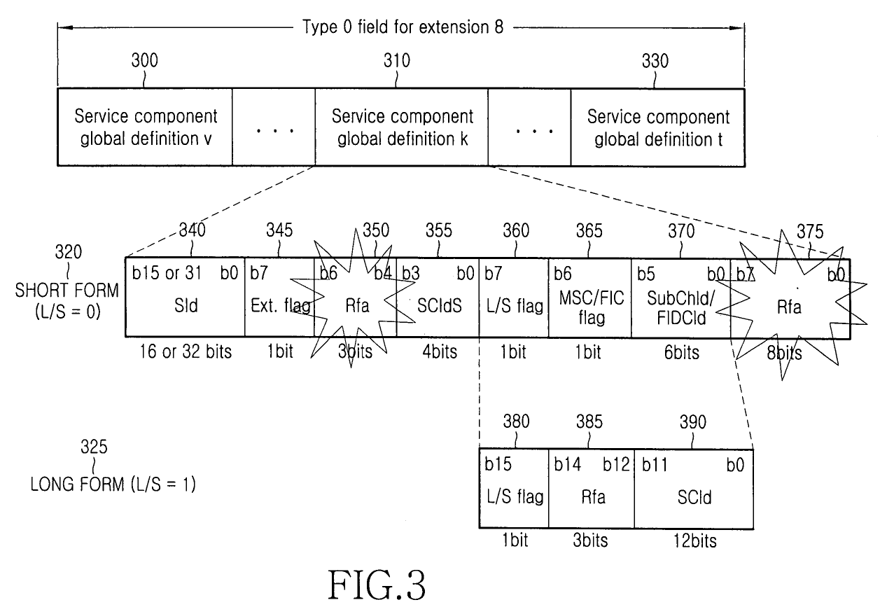

A second embodiment comprises a method for providing notice of the value of a CIF counter with a receiver at a point of time for a TII update. A Scrambling consists of a sub-channel unit, and notice of a point of time for a TII update can be provided by using a value of CIF counter of sub-channel thereof. The notice of the value of the CIF counter can be provided by using a reservation of one of fast information channels presented in the European Standard entitled “Radio Broadcasting Systems; Digital Audio Broadcasting (DAB) to Mobile, Portable and Fixed Receivers”, ETSI EN 300 401 V1.3.3(2001-05), published by the European Telecommunications Standards Institute 2001, and the European Broadcasting Union 2001, the entire disclosure of which is incorporated herein by reference. Herein, an example of available data format is a reservation of Type 0 field for extension 8 as illustrated in FIG. 3.

The second exemplary embodiment can also improve receiving capacity like the first exemplary embodiment. The same data can be transmitted all the time until update messages are reached, therefore, the second embodiment can be used with a kind of channel coding correcting the errors through the repetition of signal.

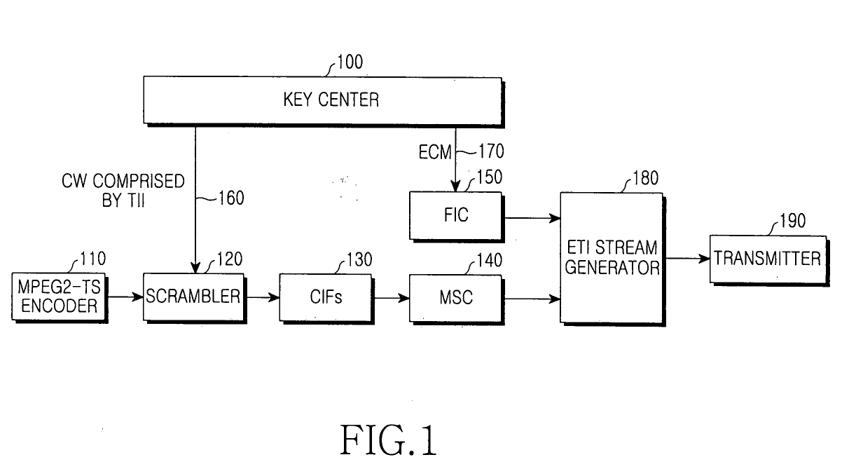

FIG. 1 is a block diagram illustrating a general T-DMB transmission system.

Referring to FIG. 1, a general T-DMB transmission system comprises a key center 100, an MPEG2-Transport Stream (MPEG2-TS) encoder 110, a scrambler 120, a common interleaved frame (CIF) 130, a main service channel (MSC) 140, a fast information channel (FIC) 150, an ensemble transport interface stream generator (hereinafter referred to as a stream generator) 180, and a transmitter 190.

Broadcast data encoding by the MPEG2-TS encoder 110 is scrambled by a control word (CW) generated in the key center 100. The MSC 140 is made up of the scrambled data as provided from the CIF 130. Also, the FIC 150 comprises entitlement checking messages (ECM) provided from the key center 100. The MSC and FIC are multiplexed into a transmission frame by the steam generator 180. The transmission frame is then transmitted to a receiver through the transmitter 190. That is, the CW is transmitted to a receiver by encryption as the ECM.

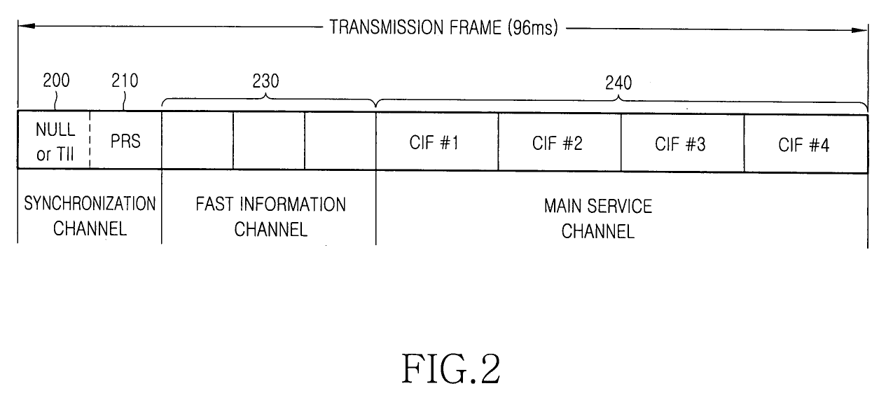

FIG. 2 illustrates a structure of an exemplary T-DMB transmission frame in accordance with an embodiment of the present invention.

Referring to FIG. 2, the T-DMB transmission frame comprises synchronization channel (SC) parts 200 and 210, fast information channel (FIC) part 230, and main service channel (MSC) part 240. Also, the SC parts 200 and 210 comprise a slot for a TII or null symbol 200, and a slot for a phase reference symbol (PRS) 210. The FIC part 230 comprises a plurality of fast information blocks (FIB) including a plurality of fast information groups (FIG). The MSC part 240 comprises a plurality of CIFs.

Herein, the TII is not transmitted in another transmission frame if the TII is transmitted in a transmission frame. A transmission time is determined according to transmission modes such as a Digital Audio Broadcasting (DAB) scheme.

FIG. 3 illustrates an exemplary data format that is capable of positioning the value of the CIF in FIG Type 0 field for extension 8 in accordance with an embodiment of the present invention.

Referring to FIG. 3, the FIG Type 0 field for extension 8 is a data format defined by the ETSI EN 300 401 V1.3.3(2001-05) standards, referenced above. The FIG Type 0 field for extension 8 comprises a plurality of service component global definitions 300, 310 and 330. Each of the service component global definitions 300, 310 and 330 comprise Sid 340, Ext. flag 345, Rfa 350 and 375, SCIds 355, and L/S flag 360 and 380.

Moreover, the FIG Type 0 field for extension 8 further comprises a 1 bit MSC/FIC flag 365 and a 6 bit SubChld/FIDCID 370 in the case of a short form. The FIG Type 0 field for extension 8 further comprises a 3 bit Rfa 385 and a 12 bit SCld in the case of a long form. A value of the CIF counter can be placed at Rfa 350 and 375 in the component global definitions 300, 310 and 330.

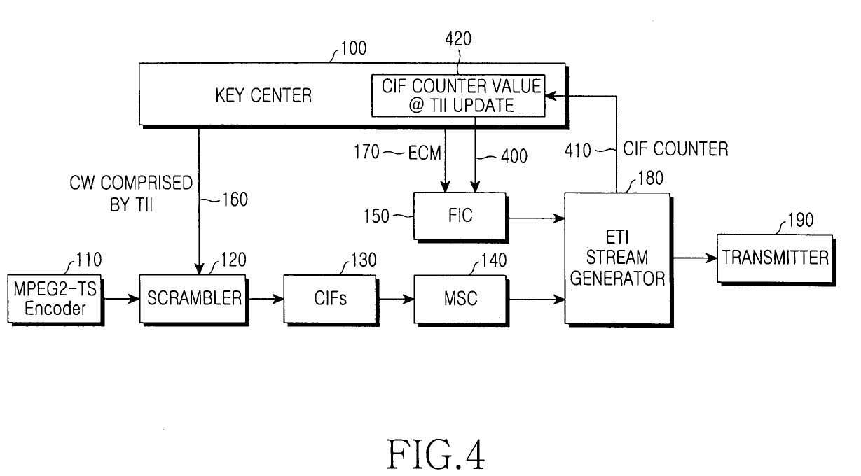

FIG. 4 is a block diagram illustrating a structure of an exemplary T-DMB transmission system in accordance with an embodiment of the present invention.

Referring to FIG. 4, a data flow of a transmission system according to an embodiment of the present invention adds data paths to a data flow of a general transmission system as illustrated FIG. 1. That is, a configuration according to an embodiment of the present invention adds a data path 410 for providing notice of a CIF counter from the stream generator 180 to the key center 100, corresponding to the first exemplary embodiment described above. Another configuration according to an embodiment of the present invention adds a message path 400 for providing notice of CIF counter update information 420 from the key center 100 to the FIC 150, corresponding to the second embodiment described above.

A detailed description of data flow according to embodiments of the present invention can be illustrated by adding the configurations described above into a data flow description of the general transmission system of FIG. 1.

Furthermore, both the key center 100 and other function blocks of FIG. 4 can be substituted by any number of suitable function blocks, such as a controller.

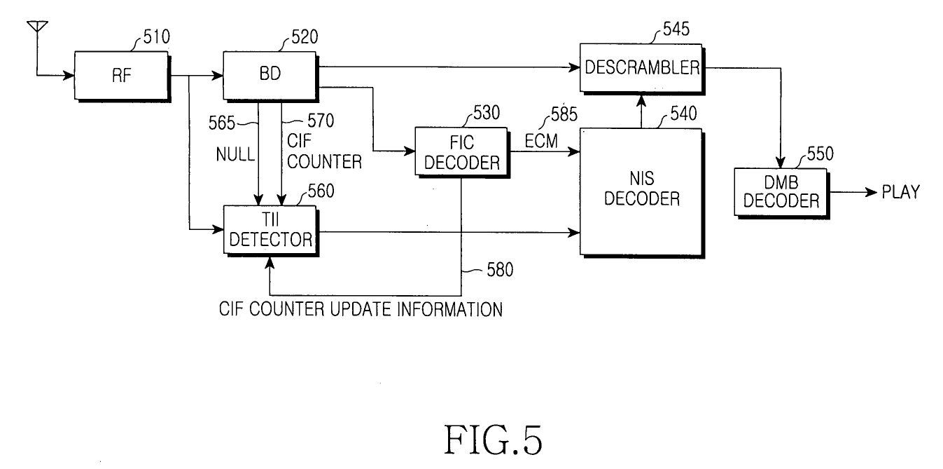

FIG. 5 is a block diagram illustrating an exemplary structure of a T-DMB receiver in accordance with an embodiment of the present invention;

Referring to FIG. 5, the receiver comprises a radio frequency (RF) block 510, a broadcasting data (BD) block 520, a FIC decoder 530, an NIS decoder 540, a descrambler 545, a DMB decoder 550, and a TII detector 560.

Herein, the RF block 510 receives a T-DMB radio frequency, the BD block 520 decodes the synchronization channel in broadcast data provided from the RF block 510. The TII detector 560 detects the TII by using the TII provided from the RF block 510 with a null symbol 565 and a common interleaved frame (CIF) counter 570 provided from the BD block 520.

The fast information channel (FIC) decoder 530 decodes the FIC in broadcast data provided from the BD block 520, and the network identification system (NIS) decoder 540 identifies a network by using the TII and entitlement checking messages (ECM) 585 provided from the FIC decoder 530.

The descrambler 545 descrambles broadcast data provided from the BD block 520 and network identification information (NII) provided from the NIS decoder 540. Also, the broadcasting data decoder 550 plays visible media by decoding a main service channel (MSC) of broadcast data provided from the descrambler 545. Herein, it is preferable that the TII detector 560 is also provided with CIF counter update information from the FIC decoder 530.

That is, a configuration according to an embodiment of the present invention adds a data path 570 for inputting a CIF counter from the BD block 520 to the inside of a T-DMB receiver, corresponding to the first exemplary embodiment described above. Another configuration according to an embodiment of the present invention adds a message path 580 for providing notice of CIF counter update information from the FIC decoder 530 to the TII detector 560, corresponding to the second embodiment described above.

Furthermore, any of the function blocks of FIG. 5 can be substituted by any number of suitable function blocks, such as a controller.

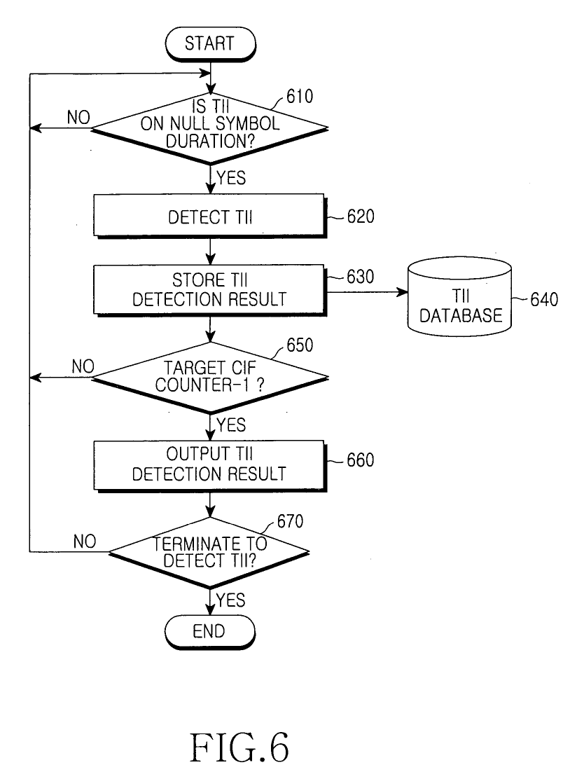

FIG. 6 is a flow chart illustrating an exemplary method of detecting TII in a T-DMB receiver in accordance with the first exemplary embodiment of the present invention described above.

Referring to FIG. 6, in step 610, the receiver synchronizes frames by using a null symbol of a synchronization duration, and determines whether the TII occurs during the slot for a null symbol. In step 620, the receiver demodulates to detect if the TII signal is received with a null symbol.

In steps 630 and 640, the demodulated TII is stored into a TII database preferably continuously until the value of “Common Interleaved Frame (CIF) counter-1” is detected.

In step 650, the receiver determines whether the value of the Common Interleaved Frame (CIF) counter is a predetermined target value of “CIF counter-1”. In step 660, the receiver outputs the TII detection result when the value of “Common Interleaved Frame (CIF) counter-1” is reached. Herein the detection result is only output as a value of the detected TII, or output as a maximum frequency value of the detected TII associated with an accumulative or average value of the detected TII thereof, by a TII detection reporting policy.

In step 670, the receiver determines whether to terminate the TII detection flow according to a TII detection termination.

Herein, the exemplary method for providing notice of the target CIF counter is different between the first exemplary embodiment and the second exemplary embodiment. As the first exemplary embodiment fixes a point of time for a TII update with a specific CIF counter value, the value of the CIF counter is already known by the transmission system, and the receiver is notified of the value of the target CIF counter.

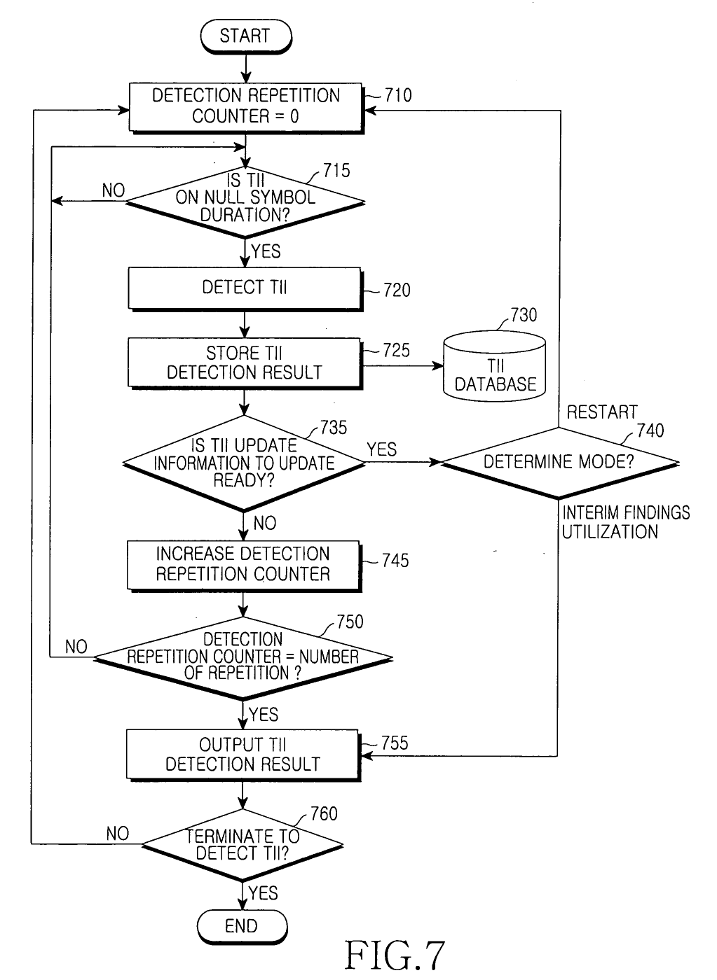

Moreover, as the second embodiment provides notification of a point of time for a TII update via fast information group (FIG), a transmission system provides notification of a point of time for a TII update via FIG. 0 field extension 8 to a receiver. Therefore, the receiver can be notified of the value of the target CIF counter after FIG decoding. As described above, logical configuration of providing notification of the value of the target CIF counter to a TII detector is added in the second exemplary embodiment. The action of a receiver in this case, is described in the following FIG. 7.

FIG. 7 is a flow chart illustrating an exemplary method of detecting TII in a T-DMB receiver in accordance with a second exemplary embodiment of the present invention.

Referring to FIG. 7, in step 710, the receiver initializes a value of a detection repetition counter. In step 715, the receiver determines whether the TII occurs during the slot for a null symbol. In step 720, the receiver demodulates to detect the TII signal in the case where the TII occurs during the slot for a null symbol, and repeats this step in the case where the TII does not occur during the slot for a null symbol.

In steps 725 and 730, the receiver stores the detected TII into a TII database preferably continuously until TII update information is ready to be updated.

In step 735 step, the receiver determines whether the TII exists, and whether TII update information is ready to be updated. In step 740, the receiver determines a mode in the case where the TII exists and the TII update information is ready to be updated. If the mode is a restart mode, the receiver returns to step 710. If the mode is a utilization mode of interim findings, the receiver jumps to step 755.

In step 745, the receiver increases the value of the detection repetition counter, except in the case of a point of time for a TII update.

In step 750, the receiver determines whether the detection repetition counter is a repeated number. If the detection repetition counter is a repeated number, in step 755, the receiver outputs a TII detection result. If the detection repetition counter is not a repeated number, the receiver returns to step 715.

In step 760 step, the receiver determines whether to terminate TII detection flow according to a TII detection termination. If it does not terminate the TII detection, the receiver returns to step 710.

As is apparent from the above description, according to exemplary embodiments of the present invention, a TII detection probability can be set up by using the statistics or accumulated same value in a TII detector, because a prior value is sustained until the value of the TII varies by notifying a point of time for the TII update.

Also, as is apparent from the above description, according to exemplary embodiments of the present invention, capability of the included hardware can be optimized if the TII is detected in the receiver, because the TII detector does not need to operate any further.

Although certain exemplary embodiments of the present invention have been described for illustrative purposes, those skilled in the art will appreciate that various modifications, additions, and substitutions are possible, without departing from the scope of the present invention that is defined by the following claims, along with full scope of their equivalents.

What is claimed is:

1. A method for determining transmitter identification information (TII) in a terrestrial digital multimedia broadcasting (T-DMB) system, the method comprising the steps of:
detecting the TII occurs during the slot for a null symbol;
storing the detected TII into a TII database until a point of time for a TII update; and
outputting a TII detection result at the point of time for the TII update,
wherein the point of time for the TII update comprises a time when the value of a Common Interleaved Frame (CIF) counter is a predetermined target value.

2. The method as claimed in claim 1, wherein the detection result is output as a value of the detected TII.

3. The method as claimed in claim 1, wherein the detection result is output as a maximum frequency value of the detected TII associated with an accumulative or average value of the detected TII thereof.

4. A method for determining transmitter identification information (TII) in a terrestrial digital multimedia broadcasting (T-DMB) system, the method comprising the steps of:
initializing a value of a detection repetition counter;
detecting the TII during the slot for a null symbol;
storing the detected TII into a TII database until a point of time for a TII update;
increasing the value of the detection repetition counter except in the case of a point of time for a TII update, and determining whether the detection repetition counter is a predetermined target value; and
outputting a TII detection result at the point of time for the TII update,
wherein information comprising the point of time for a TII update is transmitted via a predetermined field.

5. The method as claimed in claim 4, further comprising the step of determining a mode at the point of time for a TII update.

6. The method as claimed in claim 5, wherein the mode comprises a restart mode for returning to the step of initializing, or a utilization mode of interim findings for jumping to the step of outputting.

7. The method as claimed in claim 4, wherein the predetermined field is Fast Information Group (FIG) Type 0 field for extension 8.

8. The method as claimed in claim 4, wherein the detection result is output as a value of the detected TII.

9. The method as claimed in claim 4, wherein the detection result is output as a maximum frequency value of the detected TII associated with an accumulative or average value of the detected TII thereof.

10. A transmission system for determining transmitter identification information (TII) in a terrestrial digital multimedia broadcasting (T-DMB) system, the system comprising:
a key center for storing a value of a Common Interleaved Frame (CIF) counter;
a Fast Information Channel (FIC) for including CIF counter update information provided from the key center at a predetermined field when the TII is updated;
a Main Service Channel (MSC) comprising broadcast data;
a stream generator for generating a frame by multiplexing the FIC and the MSC; and
a transmitter for transmitting the multiplexed frame.

11. The system as claimed in claim 10, wherein the key center is provided a value of the CIF counter from the stream generator.

12. A receiver for determining transmitter identification information (TII) in a terrestrial digital multimedia broadcasting (T-DMB) system, the receiver comprising:
a radio frequency (RF) block;
a broadcasting data (BD) block for decoding a synchronization channel (SC) in broadcast data provided from the RF block;
a detector for detecting the TII by using a null symbol and a common interleaved frame (CIF) counter provided from the BD block;
a fast information channel (FIC) decoder for decoding the FIC in broadcast data provided from the BD block;
a network identification system (NIS) decoder for identifying a network by using the TII and entitlement checking messages (ECM) provided from the FIC decoder;
a descrambler for descrambling broadcast data provided from the BD block and a network identification information (NII) provided from the NIS decoder; and
a broadcasting data decoder for decoding a main service channel (MSC) of broadcast data provided from the descrambler,
wherein the detector is provided with CIF counter update information from the FIC decoder.
